(19) United States
(12) Patent Application Publication
(10) Pub. No.: US 2007/0094540 A1
(43) Pub. Date: Apr. 26, 2007

(54) Program analysis program, program analysis device, and program analysis method

(75) Inventors: Manabu Kamimura, Kawasaki (JP); Akihiko Matsuo, Kawasaki (JP); Kenichi Kobayashi, Kawasaki (JP); Toshiaki Yoshino, Kawasaki (JP); Toshiaki Gomi, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 11/339,668

(22) Filed: Jan. 26, 2006

(30) Foreign Application Priority Data
Oct. 26, 2005 (JP) 2005-310684

(51) Int. Cl. G06F 11/00

(52) U.S. Cl. 714/38

(57) ABSTRACT

The present invention provides a program analysis program, a program analysis device, and a program analysis method which can analyze programs and obtain input/output information of the programs effectively. The program analysis device includes an execution path detection unit that detects an execution path and a variable from a group of programs, an execution path pursuit unit that pursues the detected execution path and variable, a variable value limitation unit that seeks values that the variable can turn out to be along with the pursuit for execution path, and limits the variable value in the execution path to be pursued afterward, an execution path limitation unit that, in case there arises a point at which the execution path branches depending on a condition that the variable value satisfies in the pursuit for execution path, after the branch point, limits the pursued execution path only to an execution path in which the limited variable value satisfies the condition, and an input/output information acquisition unit that, in case there arises a point at which data is input or output in the pursuit for execution path, acquires the input/output information.

### BACKGROUND OF THE INVENTION

1. Field of the Invention

The present invention relates to the reverse engineering technique for an application property.

2. Description of the Related Art

A computer system, which was once established, sometimes has to be upgraded or has to have its entire system reexamined with the lapse of time. At this time, it is necessary to collect the specification documents of a computer system to be reestablished, and figure out how the computer system is working from the information in the collected documents. However, sometimes such documents cannot be sufficiently obtained due to the change of management system, transfer of persons in charge, etc., from the time of development.

Furthermore, since a computer system is large in scale and complicated, a great number of man-hours are required for the work of correctly grasping input/output information of a system to be reestablished.

To solve the problem, there is an approach of analyzing an application property of a computer system by using document generating tools which analyze each program and assembling those generated documents so as to capture the whole structure. This approach is referred to as a reverse engineering. According to the conventional reverse engineering technique, calling structure between individual programs and jobs, and information of data to which respective programs have an access can be extracted.

Furthermore, as a method to pursue an execution path of a program and carry out analysis, there is known a symbolic execution. In the symbolic execution, an execution path in a program is pursued for all variables, and in case there is a branch, analysis is carried out for each path. This analysis is applied to all branches so that the number of generated paths can be extremely large.

As a conventional technique related to the present invention, there is known a Patent Document 1 (Jpn. Pat. AppIn. Laid-Open Publication No. 2002-215391). The program analysis device, program analysis method, and recording medium analyze a program, and generate a block diagram of the program.

However, in many systems which undergo the reverse engineering, for data such as primary databases and files used in the systems, there are many programs which write the data by having an access using a program or processing called a common access routine, and there are a few programs in which a business logic has an access to databases and files directly. Accordingly, by just only combining the extraction technique of calling structure and input/output information of respective programs, which manner is utilized in the conventional reverse engineering, many databases which are not accessed in reality are undesirably obtained, which prevents analysis of high accuracy. Furthermore, in case of analyzing a large-scale application property, many memories and much processing time are required for the analysis, which may prevent obtaining analysis result of sufficient accuracy within limited time.

On the other hand, in the symbolic execution, values of all variables are retained, and execution paths having the possibility of execution are to be analyzed. So, similar to above-described problems, in case of analyzing a large-scale application property, many memories and much processing time are required for the analysis, which may prevent obtaining analysis result of sufficient accuracy within limited time.

Under the conventional reverse engineering technique, it is impossible to figure out which processing in an application property has an access to certain data with high accuracy.

Under the reverse engineering technique disclosed in the patent document 1, since analysis is performed by tracking back a subject program, when the number of noticeable statements increases, the number of times of tracking back increases accordingly, which undesirably increases execution time period.

Additionally, under the reverse engineering technique disclosed in the patent document 1, input/output information of subject processing cannot be assembled in the form of a specification, which requires manual procedures in writing input/output information.

### SUMMARY OF THE INVENTION

It is therefore an object of the present invention to overcome the above-mentioned drawbacks by providing a program analysis program, a program analysis device, and a program analysis method which can analyze programs and obtain input/output information of the programs effectively.

To solve above-described problems, the present invention provides a program analysis program that makes a computer analyze a group of programs, the program analysis program making the computer carry out the steps of: an execution path detection step that detects an execution path and a variable from the group of programs; an execution path pursuit step that pursues the execution path and variable detected by the execution path detection step; a variable value limitation step that seeks values that the variable can turn out to be along with the pursuit for execution path by the execution path pursuit step, and limits the variable value in the execution path to be pursued afterward; an execution path limitation step that, in case there arises a point at which the execution path branches depending on a condition that the variable value satisfies in the pursuit for execution path by the execution path pursuit step, after the branch point, limits the execution path pursued by the execution path pursuit step only to an execution path in which the variable value limited by the variable value limitation step satisfies the condition; and an input/output information acquisition step that, in case there arises a point at which data is input or output in the pursuit for execution path by the execution path pursuit step, acquires in the input/output information.

In the program analysis program according to the present invention, after the input/output information acquisition step, the program makes the computer carry out a program analysis result output step that outputs the execution path pursued by the execution path pursuit step and the input/output information detected by the input/output information acquisition step as program analysis result.

In the program analysis program according to the present invention, between the execution path detection step and the execution path pursuit step, the program makes the computer carry out a variable limitation step that limits the variable detected by the execution path detection step only to a variable which has an influence on the execution path or inputting/outputting data.

In the program analysis program according to the present invention, the variable which has an influence on the execution path or inputting/outputting data is any one of a variable used as an argument in calling a program, a variable used as a condition, or a variable used in inputting/outputting data.

In the program analysis program according to the present invention, the variable value limitation step limits the variable value in the execution path that branches depending on a condition to a variable value that satisfies the condition.

In the program analysis program according to the present invention, when the pursuit for the execution path that branches depending on a condition is ended, values that the variable can turn out to be in case of satisfying the condition and values that the variable can turn out to be in case of not satisfying the condition are set in a variable value limitation unit.

The present invention also provides a program analysis device that analyzes a group of programs, including: an execution path detection unit that detects an execution path and a variable from the group of programs; an execution path pursuit unit that pursues the execution path and variable detected by the execution path detection unit; a variable value limitation unit that seeks values that the variable can turn out to be along with the pursuit for execution path by the execution path pursuit unit, and limits the variable value in the execution path to be pursued afterward; an execution path limitation unit that, in case there arises a point at which the execution path branches depending on a condition that the variable value satisfies in the pursuit for execution path by the execution path pursuit unit, after the branch point, limits the execution path pursued by the execution path pursuit unit only to an execution path in which the variable value limited by the variable value limitation unit satisfies the condition; and an input/output information acquisition unit that, in case there arises a point at which data is input or output in the pursuit for execution path by the execution path pursuit unit, acquires the input/output information.

The program analysis device according to the present invention further includes: a program analysis result output unit that outputs the execution path pursued by the execution path pursuit unit and the input/output information detected by the input/output information acquisition unit as program analysis result.

The program analysis device according to the present invention further includes: a variable limitation unit that limits the variable detected by the execution path detection unit only to a variable which has an influence on the execution path or inputting/outputting data.

In the program analysis device according to the present invention, the variable which has an influence on the execution path or inputting/outputting data is any one of a variable used as an argument in calling a program, a variable used as a condition, or a variable used in inputting/outputting data.

In the program analysis device according to the present invention, the variable value limitation unit limits the variable value in the execution path that branches depending on a condition to a variable value that satisfies the condition.

The present invention also provides a program analysis method that analyzes a group of programs, including: an execution path detection step that detects an execution path and a variable from the group of programs; an execution path pursuit step that pursues the execution path and variable detected by the execution path detection step; a variable value limitation step that seeks values that the variable can turn out to be along with the pursuit for execution path by the execution path pursuit step, and limits the variable value in the execution path to be pursued afterward; an execution path limitation step that, in case there arises a point at which the execution path branches depending on a condition that the variable value satisfies in the pursuit for execution path by the execution path pursuit step, after the branch point, limits the execution path pursued by the execution path pursuit step only to an execution path in which the variable value limited by the variable value limitation step satisfies the condition; and an input/output information acquisition step that, in case there arises a point at which data is input or output in the pursuit for execution path by the execution path pursuit step, acquires the input/output information.

According to the present invention, by pursuing an execution path and limiting a variable value, only input/output information which has the possibility of being actually input or output can be obtained.

### BRIEF DESCRIPTION OF THE DRAWINGS

FIG. 1 shows a block diagram indicative of one example of the configuration of the program analysis device of the present invention;

FIG. 2 shows a flowchart indicative of one example of the performance of program analysis processing by the program analysis device of the present invention;

FIG. 3 shows a source code indicative of PROGRAMA among specific examples of an application property;

FIG. 4 shows a source code indicative of PROGRAMB among specific examples of the application property;

FIG. 5 shows a source code indicative of PGDATA_D among specific examples of the application property;

FIG. 6 shows an example of a processing structure diagram generated by the conventional reverse engineering technique; and

FIG. 7 shows an example of a processing structure diagram generated by the program analysis device of the present invention.

### DETAILED DESCRIPTION OF THE PREFERRED EMBODIMENTS

The present invention will further be described below with reference to the accompanying drawings.

Firstly, the configuration of the program analysis device will be explained.

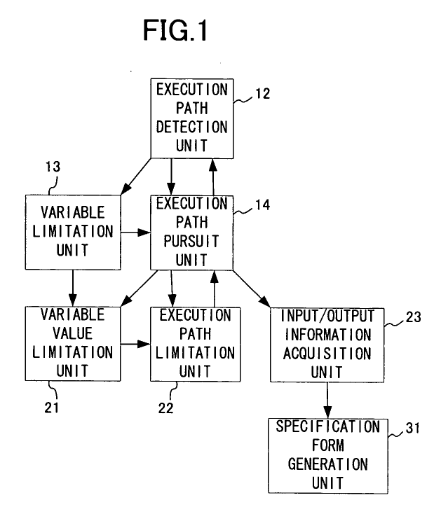

FIG. 1 shows a block diagram indicative of one example of the configuration of the program analysis device of the present invention. The program analysis device includes an execution path detection unit 12, a variable limitation unit 13, an execution path pursuit unit 14, a variable value limitation unit 21, an execution path limitation unit 22, an input/output information acquisition unit 23, and a specification form generation unit 31.

Next, the performance of program analysis processing by the program analysis device will be explained.

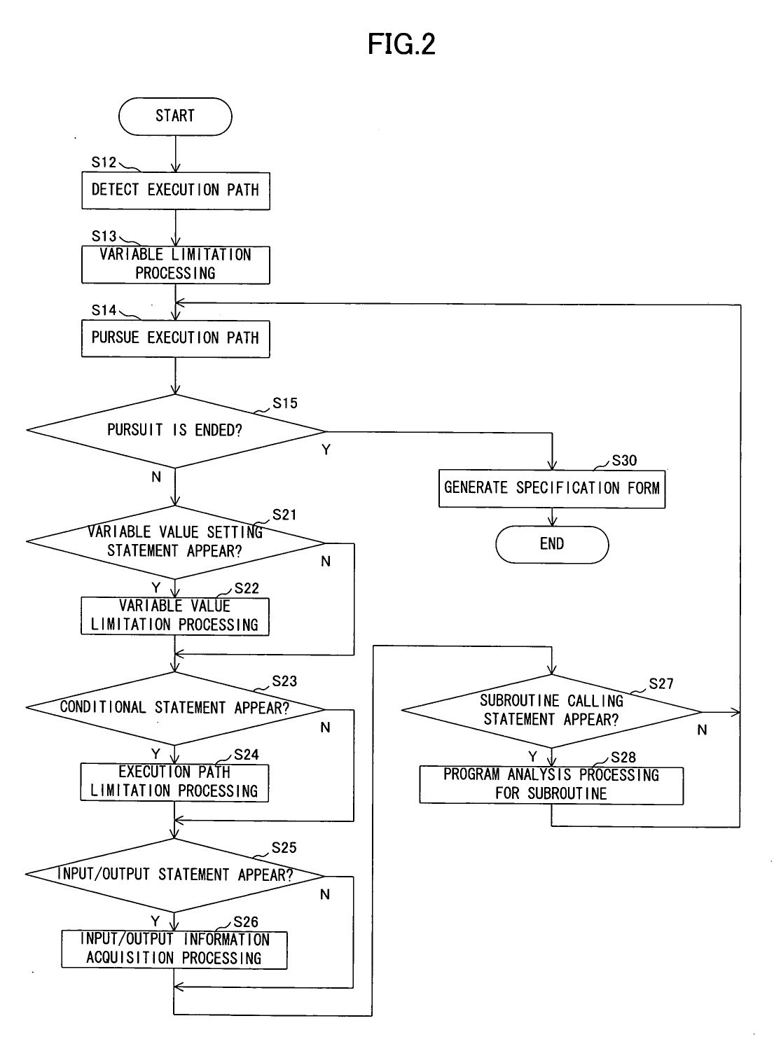

FIG. 2 shows a flowchart indicative of one example of the performance of program analysis processing by the program analysis device of the present invention. Before executing the first program analysis processing, a program for which analysis is started is specified preliminarily among an application property in accordance with an instruction of the user, and thus specified program is set to be a subject program, or a program to be analyzed. As will be described later, in case program analysis processing of a subroutine is carried out in the program analysis processing, the subroutine is set to be a subject program.

Next, the execution path detection unit 12 obtains the subject program included in the application property and carries out syntax analysis for the subject program so as to detect an execution path of the subject program from the beginning thereof to retain the result as execution path information (S12).

Next, the variable limitation unit 13 performs variable limitation processing (S13). As the variable limitation processing, the variable limitation unit 13 detects a variable to be used in a conditional expression containing therein an input/output instruction statement and a calling statement from the execution path information, and retains the detected variable as variable information. Furthermore, the variable limitation unit 13 detects a variable to be used as an argument of a subroutine calling statement from the execution path information, and retains the detected variable as variable information. Moreover, the variable limitation unit 13 detects a variable which has its value set to be of a variable to be used in the above-described conditional expression or a variable to be used as an argument of the above-described subroutine calling statement from the execution path information, and retains the detected variable as variable information.

Next, the execution path pursuit unit 14 pursues an execution path using the execution path information (S14), and judges whether or not the pursuit is ended (S15). In case the pursuit is ended (S15, Y), the specification form generation unit 31 generates a specification form (S30), and the flow is ended.

On the other hand, in case the pursuit is not ended (S15, N), the variable value limitation unit 21 judges whether or not a variable value setting statement for a variable in the variable information appears in pursuing an execution path (S21). In case a variable value setting statement does not appear (S21, N), the processing goes to S23. On the other hand, in case a variable value setting statement appears (S21, Y), the variable value limitation unit 21 performs variable value limitation processing (S22). As the variable value limitation processing, the variable value limitation unit 21 judges whether or not a variable value set up by the variable value setting statement is limited, and limits a subsequent variable value in case the limitation is possible, and retains the variable value as variable value information.

Next, the execution path limitation unit 22 judges whether or not a conditional statement appears in the pursuit (S23). In case a conditional statement does not appear (S23, N), the processing goes to S25. On the other hand, in case a conditional statement appears (S23, Y), the execution path limitation unit 22 performs execution path limitation processing (S24). As the execution path limitation processing, the execution path limitation unit 22 applies a variable value of the variable value information to the conditional statement so as to judge whether or not an execution path is limited. In case the limitation is possible, the execution path limitation unit 22 retains the limited execution path as execution path information. On the other hand, in case the limitation is impossible, the execution path limitation unit 22 analyzes an execution statement in all conditions. At this time, in an execution statement for each condition, a variable value is limited as to satisfy each condition. Furthermore, a variable value set up in an execution statement for each condition is retained in the variable value information, and is used as a limited variable value after the conditional statement is ended.

Next, the input/output information acquisition unit 23 judges whether or not an input/output statement for data appears in the pursuit (S25). In case an input/output statement does not appear (S25, N), the processing goes to S27. On the other hand, in case an input/output statement appears (S25, Y), the input/output information acquisition unit 23 performs input/output information acquisition processing of acquiring and retaining input/output information related to input/output of data (S26).

Next, the execution path detection unit 12 judges whether or not a subroutine calling statement appears in the pursuit (S27). As a subroutine calling statement, for example, in case of the COBOL language, there are extracted section calling (PERFORM statement), program calling (CALL statement), and transfer (GOTO statement). In case a subroutine calling statement does not appear (S27, N), the processing returns to S14 to continue the pursuit. On the other hand, in case a subroutine calling statement appears (S27, Y), the execution path detection unit 12 performs program analysis processing with a subroutine, to which a variable value obtained from the variable value information is given as an argument, set to be a subject program, and receives the result of the program analysis processing (S28), returning to processing S14 to continue the pursuit.

Next, the performance of the program analysis device will be explained using a specific example of an application property.

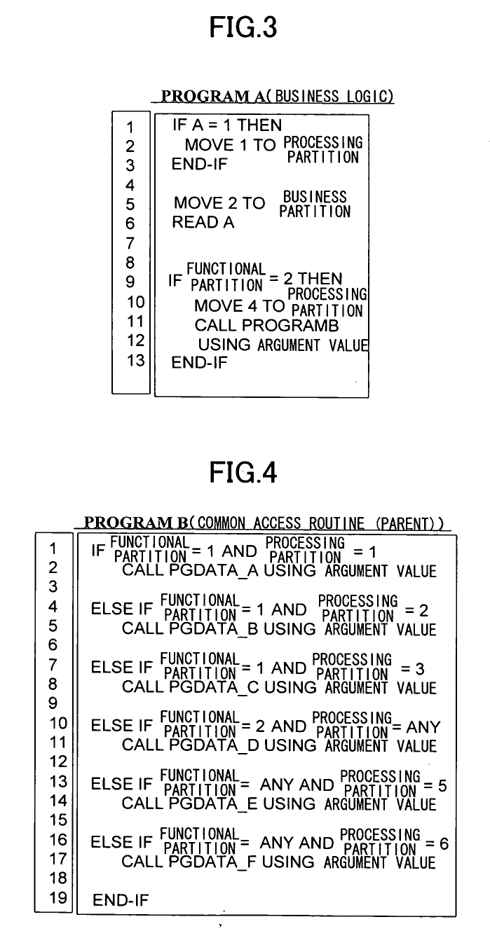

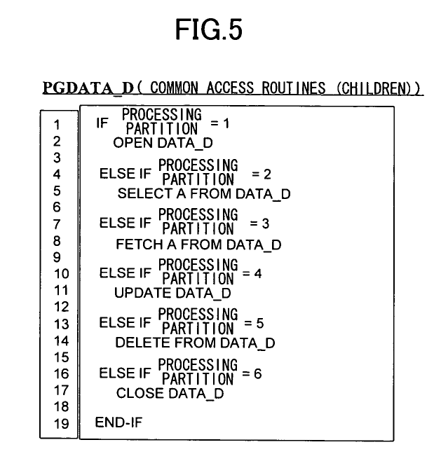

As an example, there is an application property which is written by the COBOL language, and constructed by respective programs of a PROGRAMA being a business logic, a PROGRAMB being a common access routine (parent), a PGDATA_A, a PGDATA_B, a PGDATA_C, a PGDATA_D, a PGDATA_E, and a PGDATA_F being common access routines (children). FIG. 3 shows a source code indicative of the PROGRAMA among specific examples of the application property. FIG. 4 shows a source code indicative of the PROGRAMB among specific examples of the application property. FIG. 5 shows a source code indicative of the PGDATA_D among specific examples of the application property.

Firstly, as a first subject program, the PROGRAMA being a calling invoker is specified by the user, and program analysis processing with the PROGRAMA set to be a subject program is started.

Next, by the variable limitation processing, as a variable which has an influence on the execution and needs pursuit, a functional partition used as an argument, a processing partition, a business partition, a functional partition used as a condition, A are detected and retained in the variable information. Hereinafter, a variable to be pursued are limited to those.

Next, the pursuit for execution path will be explained.

Since the true or false of a condition cannot be judged by the first line “IF A=1 THEN”, the execution path limitation unit 22 pursues in the true case and in the false case.

In case the first line is true, the variable value limitation unit 21 limits the value of A to 1 in an execution statement at the time of true, and retains the value in the variable value information. Next, the variable value limitation unit 21 limits the value of processing partition to 1 by the second line “MOVE 1 TO processing partition”, and retains the value in the variable value information. At this time, since the true or false cannot be judged, when the execution statement at the time of true is ended, the variable value limitation unit 21 retains the value of 1 or the original state in the variable value information. In case the first line is false, the variable value limitation unit 21 pursues, and after the pursuit, the processing goes on with the value of 1 at the time of true, at the time of false, or the original state being retained in the variable value information. In case the true or false can be judged, the variable value limitation unit 21 analyzes only one condition satisfying the condition, and the latest state at the time of carrying out the pursuit is continuously retained in the variable value information, the original state not being considered.

In the PROGRAMA, the variable value limitation unit 21 limits the value of business partition to 2 by the fifth line “MOVE 2 TO business partition”, and retains the value in the variable value information. Next, the input/output information acquisition unit 23 retains input information A in the input/output information by the sixth line “READ A”.

Next, since the true or false of a condition cannot be judged by the ninth line “IF functional partition=2 THEN”, the execution path limitation unit 22 pursues in case of the true and in case of the false. In case the ninth line is false, since the PROGRAMA is ended, the pursuit for execution path in this case is ended.

Next, the pursuit for execution path in case the ninth line is true will be explained.

The variable value limitation unit 21 limits the value of functional partition being a condition to 2, and retains the value in the variable value information in the condition. Next, the variable value limitation unit 21 limits the value of processing partition to 4 by the tenth line “MOVE 4 TO processing partition”, and retains the value in the variable value information. Next, the execution path detection unit 12 carries out program analysis processing with the PROGRAMB set to be a subject program by the eleventh and twelfth line “CALL PROGRAMB USING argument value”. Respective variable values are given as argument values of the PROGRAMB, and values of the functional partition, processing partition, and business partition are limited such that the functional partition=2, processing partition=4, and business partition=2, which are retained in the variable value information.

In the PROGRAMB, of conditional statements of the first to nineteenth lines, so as to satisfy the condition of tenth line “ELSE IF functional partition=2 AND processing partition=ANY”, the execution path detection unit 12 carries out program analysis processing with the PGDATA_D set to be a subject program by the eleventh line “CALL PGDATA_D USING argument value”. Similar to the PROGRAMB, respective variable values are given as argument values of the PGDATA_D, and values of the functional partition, processing partition, and business partition are limited such that the functional partition=2, processing partition=4, and business partition=2, which are retained in the variable value information.

In the PGDATA_D, of conditional statements of the first to nineteenth lines, so as to satisfy the condition of tenth line “ELSE IF processing partition=4”, the input/output information acquisition unit 23 retains output information DATA_D in the input/output information by an output statement of the eleventh line “UPDATE DATA_D”. Then, the PGDATA_D is ended, and the PROGRAMB is ended, and the condition part is ended. After the condition is ended, together with variable values at the time of not performing the condition, functional partition=2 or indefinite, processing partition=4 or indefinite are retained in the variable value limitation unit 21. In this case, since the PROGRAMA is ended, the pursuit for execution path is ended.

Next, the specification form generation unit 31 generates and outputs a specification form using the input/output information. Hereinafter, generating a processing structure diagram of the specification form will be explained. The processing structure diagram has written therein together calling structure in program, input/output information, input/output information at calling destination. Here, a processing structure diagram generated by the conventional reverse engineering technique and a processing structure diagram generated by the program analysis device according to the present invention are compared and explained.

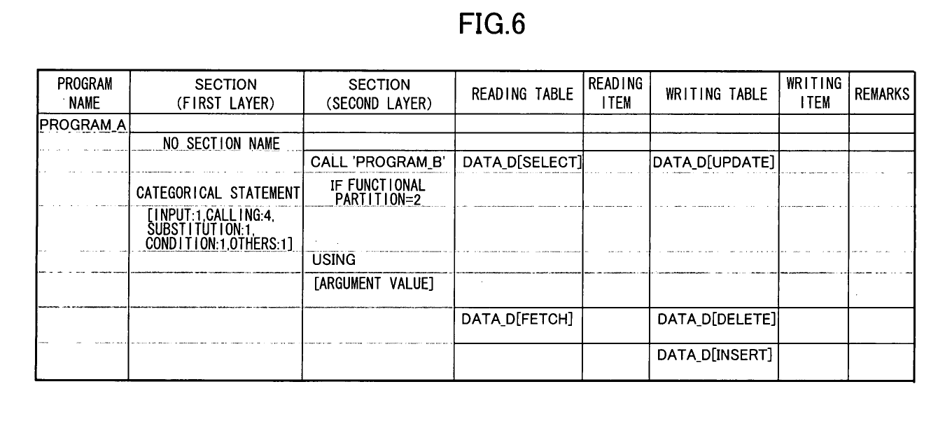

FIG. 6 shows an example of a processing structure diagram generated by the conventional reverse engineering technique. In the processing structure diagram, the PROGRAMA or a program that starts the analysis is written in program name, calling of the PROGRAMB is written in SECTION (second layer), input information (SELECT FETCH) of the input/output information is written in reading table, and output information (UPDATE, DELETE, INSERT) of the input/output information is written in writing table. Since analysis is carried out without limiting variable values in the conventional reverse engineering technique, input/output information which appears when all conditions in conditional statements are performed is written in the processing structure diagram.

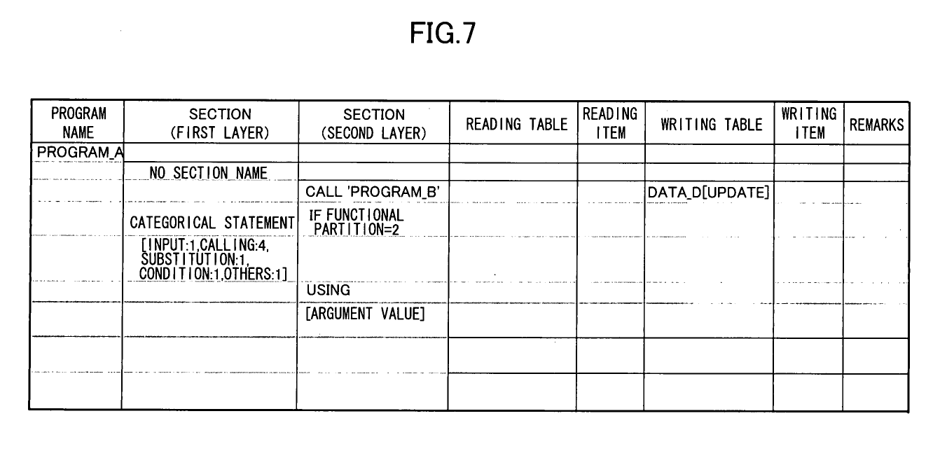

FIG. 7 shows an example of a processing structure diagram generated by the program analysis device of the present invention. Since the program analysis device of the present invention carries out analysis by limiting variable values, only input/output information that has the possibility of being actually input or output is written in the processing structure diagram. Therefore, according to the present invention, information of high accuracy can be output in the form of a specification form.

According to the present invention, since the variable limitation processing and execution path limitation processing are performed, being different from the conventional case, it is not necessary to analyze all variables and execution paths, which can significantly reduce memories and processing time required for program analysis, enabling high speed program analysis.

Furthermore, since the variable value limitation processing is performed, the execution path to be pursued can be limited, which makes it possible to obtain only input/output information that has the possibility of being actually input or output. As a result, output data amount of a specification form, etc., can be reduced, and output data comes to be easily viewable for the user.

Moreover, there may be employed a configuration in which the variable limitation unit 13 is not used and the variable limitation processing is not performed, and all variables are pursued.

Instead of employing the specification form generation unit 31, there may be employed a configuration in which a relation table between the processing and data is generated from the input/output information. Detecting the relation between all processing related to a variable limited by the variable limitation processing and input/output information, kinds of processing and kinds of data are set to the axes, thereby generating a table in which positions having relationship are marked. Using the relation table between the processing and data, the user can know which processing has an access to certain data.

Furthermore, a program that is made to execute above-described respective steps by a computer configuring the program analysis device may be provided as a program analysis program. Being stored in a recording medium whose data can be read out by a computer, the program can be executed by a computer configuring the program analysis device. The recording medium whose data can be read out by a computer may be an internal storage device such as a ROM or a RAM which is internally installed in a computer, a portable storage medium such as a CD-ROM, a flexible disk, a DVD disk, a magneto optical disk, an IC card, a database which has retained therein computer programs, or another computer and its database, and furthermore, a transmission medium on a line.

In above-described explanation, an execution path detection step corresponds to processing S12 in this embodiment. Additionally, an execution path pursuit step corresponds to processing S14 in this embodiment. Additionally, a variable value limitation step corresponds to processing. S22 in this embodiment. Additionally, an execution path limitation step corresponds to processing S24 in this embodiment. Additionally, an input/output information take-in step corresponds to processing S26 in this embodiment. Additionally, a variable limitation step corresponds to processing S13 in this embodiment. Additionally, a program analysis result output step corresponds to processing S30 in this embodiment. Additionally, a program analysis result output unit corresponds to the specification form generation unit in this embodiment.

What is claimed is:

1. A program analysis program that makes a computer analyze a group of programs, the program analysis program making the computer carry out the steps of:
an execution path detection step that detects an execution path and a variable from the group of programs;
an execution path pursuit step that pursues the execution path and variable detected by the execution path detection step;
a variable value limitation step that seeks values that the variable can turn out to be along with the pursuit for execution path by the execution path pursuit step, and limits the variable value in the execution path to be pursued afterward;
an execution path limitation step that, in case there arises a point at which the execution path branches depending on a condition that the variable value satisfies in the pursuit for execution path by the execution path pursuit step, after the branch point, limits the execution path pursued by the execution path pursuit step only to an execution path in which the variable value limited by the variable value limitation step satisfies the condition; and
an input/output information acquisition step that, in case there arises a point at which data is input or output in the pursuit for execution path by the execution path pursuit step, acquired the input/output information.

2. The program analysis program according to claim 1, which, after the input/output information acquisition step, makes the computer carry out a program analysis result output step that outputs the execution path pursued by the execution path pursuit step and the input/output information detected by the input/output information acquisition step as program analysis result.

3. The program analysis program according to claim 1, which, between the execution path detection step and the execution path pursuit step, makes the computer carry out a variable limitation step that limits the variable detected by the execution path detection step only to a variable which has an influence on the execution path or inputting/outputting data.

4. The program analysis program according to claim 3, wherein the variable which has an influence on the execution path or inputting/outputting data is any one of a variable used as an argument in calling a program, a variable used as a condition, or a variable used in inputting/outputting data.

5. The program analysis program according to claim 1, wherein the variable value limitation step limits the variable value in the execution path that branches depending on a condition to a variable value that satisfies the condition.

6. The program analysis program according to claim 5, wherein, when the pursuit for the execution path that branches depending on a condition is ended, values that the variable can turn out to be in case of satisfying the condition and values that the variable can turn out to be in case of not satisfying the condition are set in a variable value limitation unit.

7. A program analysis device that analyzes a group of programs, comprising:
an execution path detection unit that detects an execution path and a variable from the group of programs;
an execution path pursuit unit that pursues the execution path and variable detected by the execution path detection unit;
a variable value limitation unit that seeks values that the variable can turn out to be along with the pursuit for execution path by the execution path pursuit unit, and limits the variable value in the execution path to be pursued afterward;
an execution path limitation unit that, in case there arises a point at which the execution path branches depending on a condition that the variable value satisfies in the pursuit for execution path by the execution path pursuit unit, after the branch point, limits the execution path pursued by the execution path pursuit unit only to an execution path in which the variable value limited by the variable value limitation unit satisfies the condition; and
an input/output information acquisition unit that, in case there arises a point at which data is input or output in the pursuit for execution path by the execution path pursuit unit, acquires the input/output information.

8. The program analysis device according to claim 7, further comprising:
a program analysis result output unit that outputs the execution path pursued by the execution path pursuit unit and the input/output information detected by the input/output information acquisition unit as program analysis result.

9. The program analysis device according to claim 7, further comprising:
a variable limitation unit that limits the variable detected by the execution path detection unit only to a variable which has an influence on the execution path or inputting/outputting data.

10. The program analysis device according to claim 9, wherein the variable which has an influence on the execution path or inputting/outputting data is any one of a variable used as an argument in calling a program, a variable used as a condition, or a variable used in inputting/outputting data.

11. The program analysis device according to claim 7, wherein the variable value limitation unit limits the variable value in the execution path that branches depending on a condition to a variable value that satisfies the condition.

12. A program analysis method that analyzes a group of programs, comprising:
an execution path detection step that detects an execution path and a variable from the group of programs;
an execution path pursuit step that pursues the execution path and variable detected by the execution path detection step;
a variable value limitation step that seeks values that the variable can turn out to be along with the pursuit for execution path by the execution path pursuit step, and limits the variable value in the execution path to be pursued afterward;
an execution path limitation step that, in case there arises a point at which the execution path branches depending on a condition that the variable value satisfies in the pursuit for execution path by the execution path pursuit step, after the branch point, limits the execution path pursued by the execution path pursuit step only to an execution path in which the variable value limited by the variable value limitation step satisfies the condition; and
an input/output information acquisition step that, in case there arises a point at which data is input or output in the pursuit for execution path by the execution path pursuit step, acquires the input/output information.

13. The program analysis method according to claim 12, which, after the input/output information acquisition step, carries out a program analysis result output step that outputs the execution path pursued by the execution path pursuit step and the input/output information detected by the input/output information acquisition step as program analysis result.

14. The program analysis method according to claim 12, which, between the execution path detection step and the execution path pursuit step, carries out a variable limitation step that limits the variable detected by the execution path detection step only to a variable which has an influence on the execution path or inputting/outputting data.

15. The program analysis method according to claim 14, wherein the variable which has an influence on the execution path or inputting/outputting data is any one of a variable used as an argument in calling a program, a variable used as a condition, or a variable used in inputting/outputting data.

16. The program analysis method according to claim 12, wherein the variable value limitation step limits the variable value in the execution path that branches depending on a condition to a variable value that satisfies the condition.
